(19) United States
(12) Patent Application Publication
(10) Pub. No.: US 2020/0236031 A1
(43) Pub. Date: Jul. 23, 2020

(54) Blockchain Routing Protocols

(71) Applicant: HEWLETT PACKARD ENTERPRISE DEVELOPMENT LP, Houston, TX (US)

(72) Inventors: Nitin Singla, Bangalore (IN); Sunil Jayadevappa, Bangalore (IN); Yashavantha Nagaraju Naguvanahalli, Bangalore (IN)

(21) Appl. No.: 16/254,792

(22) Filed: Jan. 23, 2019

(51) Int. Cl. H04L 12/759; H04L 12/721

(52) U.S. Cl. CPC H04L 45/028; H04L 63/08; H04L 45/123

(57) ABSTRACT

A method for network communication, the method including distributing a distributed ledger across a network having a plurality of nodes and maintaining the distributed ledger on each of the plurality of nodes of the network. The method further including initiating a modification to the network, verifying the modification to the network by checking the distributed ledger maintained by each of the plurality of nodes of the network, and permitting the modification to the network when the modification to the network is authorized by the distributed ledger maintained on each of the plurality of nodes in the network.

### BACKGROUND

Computer networks may include numerous computing devices, such as, compute systems, routers, switches, and the like. Routing protocols are used to specify how routers communicate in the computer network, thereby allowing for the distribution of information between locations within the computer network. In large or complex computer networks, the open shortest path first routing protocol may be used to facilitate the distribution of information throughout the network. Open shortest path first routing protocols may use designated routers and backup designated routers to converge and route protocol traffic accordingly.

### BRIEF DESCRIPTION OF THE DRAWINGS

FIG. 1 is a schematic representation of an open shortest path first network, according to one or more examples of the present disclosure.

FIG. 2 is a schematic representation of an open shortest path first network using blockchain, according to one or more examples of the present disclosure.

FIG. 3 is a flowchart of a method for network communication, according to one or more examples of the present disclosure.

FIG. 4 is an example computing device with a hardware processor and accessible machine-readable instructions, according to one or more examples of the present disclosure.

FIG. 5 is a flowchart of a method for network, according to one or more examples of the present disclosure.

FIG. 6 is an example computing device with a hardware processor and accessible machine-readable instructions, according to one or more examples of the present disclosure.

FIG. 7 is a schematic representation of a computer processing device that may be used to implement functions and processes, according to one or more examples of the present disclosure.

### DETAILED DESCRIPTION

One or more examples are described in detail with reference to the accompanying figures. For consistency, like elements in the various figures are denoted by like reference numerals. In the following detailed description, specific details are set forth in order to provide a thorough understanding of the subject matter claimed below. In other instances, well-known features to one of ordinary skill in the art having the benefit of this disclosure are not described to avoid obscuring the description of the claimed subject matter.

Open shortest path first (“OSPF”) is a routing protocol for internet protocol (“IP”) networks. OSPF uses a link-state routing algorithm, such as Dijkstra's algorithm, that is part of a group of interior gateway protocols that operate within autonomous systems. OSPF is an interior gateway protocol that is used in large enterprise networks that may contain hundreds or thousands of nodes, where each node is representative of a computing element or like device. Examples of devices which a node may represent include, but are not limited to, computing devices, routers, switches, printers, modems, hubs, bridges, and other devices that have a network address.

Routing protocols, such as OSPF, calculate the shortest route to a destination through a network. OSPF was developed so that the shortest path through a network is calculated based on the cost of the route, taking into account bandwidth, delay, and load. Large networks may include many routing devices, and as such, heavy packet traffic may occur as a result of the number of link-state advertisements flooded across the network. A link-state advertisement (“LSA”) is a means of communication between routing devices that communicates a router's local routing topology to all other local routers in the same OSPF area. During operation, OSPF employs a designated router (“DR”)/backup designated router (“BDR”) election process. The DR is the router interface elected as the chosen path among all other routers on a particular multi-access network segment. The DR is responsible for two primary functions, originating network link-state advertisements for the network and establishing adjacencies with all routing devices on the network, thereby allowing for the synchronizing of link-state databases.

The election process also includes the election of the BDR, which serves as the backup to the DR should the DR become unavailable. Election of the DR occurs when the OSPF network is initially established. When the first OSPF links are active, the routing device with the highest router identifier is elected to be the DR. The routing device with the second highest router identifier is elected as the BDR. If the DR fails, or otherwise loses connectivity, the BDR assumes the role of the BR and a new BDR election process takes place between all remaining routers in the network.

Computer networks that have hundreds or thousands of nodes may be difficult to manage using standard routing protocols, such as OSPF. In operation, networks such as Internet of Things, always-on mobile workforce, and other large networks may include increasingly complex information technology infrastructures. As the networks expand, standard routing protocols, including OSPF, may incur numerous problems that decrease the operability of the network. For example, standard routing protocols may result in computer nodes that are located in relatively close geographic proximity. Additionally, router identification may be unique for each device and/or the network may lack design controls that could prevent unwanted devices from interacting with devices on the network. In other examples, stand routing protocols may include network values or weights that result in downtime when a portion of the network experiences problems. Furthermore, such networks use the DR/BDR election process, explained above, which results in slow convergence.

Because the DR/BDR election process is used in OSPF networks, the DR/BDR election process may affect any network employing the OSPF protocol. Implementations of the present disclosure may provide systems and methods for eliminating the DR/BDR election process. In such implementations, multiple OSPF switches and routers may be deployed and connected, thereby forming a blockchain network in a decentralized fashion. Blockchain networks may use blockchain algorithms, which provide a list of records, i.e., blocks, that are linked together using cryptography. The blocks may thus contain a cryptographic hash of a previous block, as well as time stamps, and transaction data. In such a blockchain network, each switch and router may maintain a copy of a distributed ledger that contains network information including, for example, routing information, device identifiers, network cost, as well as other OSPF configuration and/or authentication information.

In such implementations, the OSPF devices maintain a copy of their individual ledgers and share updates to the distributed ledger and thus have information about specific devices and the network in general. Accordingly, should a device no longer be available, the network is not affected. Such blockchain networks may thus provide fast and secure OSPF convergence without a DR/BDR election process, as well as provide for easier scalability when increasing network size. Additional advantages to using OSPF in a blockchain network may be set forth below as specific implementations of the present disclosure are discussed in detail.

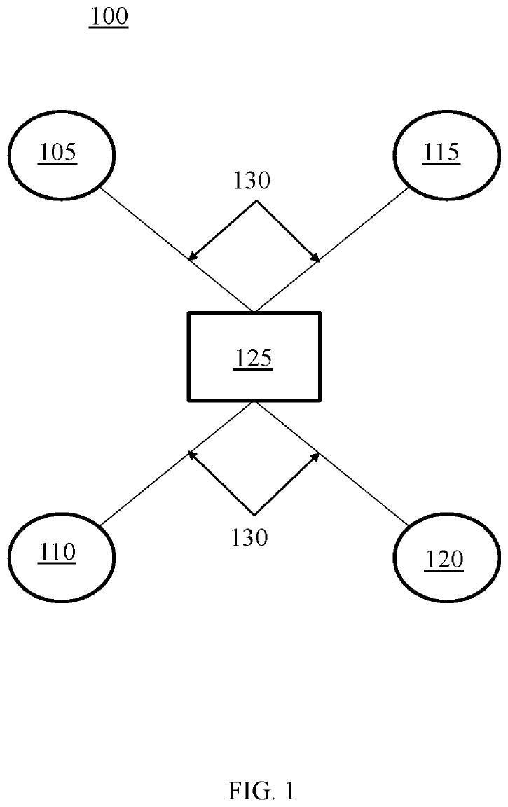

Turning to FIG. 1, a schematic representation of a topology for an OSPF network according to one or more examples of the present disclosure is shown. In this example, network 100 includes a first router 105, a second router 110, a third router 115, a fourth router 120, and a switch 125. Routers/switch 105-125 may communicate with one another through connections 130. Connections 130 may be wired or wireless, thereby allowing routers/switch 105-125 to communicate therebetween.

Collectively, the routers/switch 105-125 result in an OSPF area. An OSPF area is a set of networks and hosts that have been administrability grouped together. By dividing a larger OSPF network into areas, the number of LSAs and other OSPF overhead traffic sent over the network 100 may be reduced. LSA refers to communication of an OSPF routing protocol that communicates a device's local routing topology to all other local devices in the same OSPF area. Dividing network 100 into areas may thereby reduce the size of the topology database that each router/switch 105-125 within the area maintains.

Each router/switch 105-125 in network 100 is a node, i.e., a physical device within network 100 that is capable of sending, receiving, and/or forwarding information. Each device in network 100 has an interface IP address, an OSPF cost, and a loopback address. An IP address refers to the numerical label assigned to each device on network 100 that uses Internet Protocol for communication of devices therebetween. OSPF cost refers to the cost to deliver a packet through each link between devices in network 100. From an OSPF perspective, a least cost path is the shortest path within network 100. The cost of a link may be determined based on the bandwidth of network 100. For example, the cost of a 100 Mbps link is greater than a 1 GE link. In operation, a system administrator may define the OSPF costs for each network device. A loopback address refers to a unique IP address that may be used to test communication of devices and/or transportation of information through network 100.

To develop the network topology, router/switch 105-125 flood their respective link IP addresses to other routers/switches 105-125 in network 100. For example, first router 105 floods its link address and loopback address to switch 125 through an LSA message. Upon receiving the link address for first router 105, switch 125 floods the link address through all other devices except the device that sent the link address. In this example, switch 125 would forward the link address for first router 105 to second router 110, third router 115, and fourth router 120. The LSA message may include a link-state type, link-state identifier, and advertising router identifier. Upon receipt of the LSA message from first router 105, the switch 125 and routers 110-120 store the information in their respective OSPF link-state databases and build an OSPF topology based on the received information. After receiving the LSA message from first router 105, the other routers/switch 110-125 know first router's 105 loopback address and link addresses with the other devices in the network. This process may continue for each device within network 100 until each device has the topology for network 100.

After each device has a defined network topology, each router/switch 105-125 may calculate the shortest path to a respective destination. The shortest path information may then be saved within each router/switch 105-125 as routing information and forwarding information. Another aspect of forming network 100 includes the DR/BDR election process, which was briefly discussed above.

The DR/BDR election process generally determines the DR/BDR by electing the DR as the router with the highest OSPF priority. By default, all routers 105-120 within network 100 may have an OSPF priority of 1. However, a specific router 105-120 may be removed from participating in the DR/BDR election process if its OSPF priority is set to 0. If there is a tie between routers 105-120 during DR/BDR election, the router 105-120 with the highest router ID can be elected as the DR, while the router 105-120 with the second highest OSPF priority or router ID can become the BDR according to one example. Router ID refers to the naming convention of the router, and as such, fourth router 120 has a higher router ID than third router 115, which has a higher router ID than second router 110, which has a higher router ID than first router 105.

In this example, first router 105, second router 110, third router 115, and fourth router 120 all have an OSPF priority of 1. A such, fourth router 120 becomes the DR and third router 115 becomes the BDR because in the tie break, fourth router 120 has the highest router ID and third router 115 has the second highest router ID. In another example, fourth router 120 may have an OSPF priority of 0, while first, second, and third routers 105-115 each have an OSPF priority of 1. In such an example, third router 115 would be the DR, while second router 110 would be the BDR because in the tie break, third router 115 has the highest router ID and second router 110 has the second highest router ID. DR/BDR election may be influenced by manual manipulation of OSPF priorities, as well as router IDs.

As illustrated above, after OSPF is enabled for routers/switch 105-125 in network 100, information may be exchanged between the routers/switch 105-125, and at the end of the information exchange, the DR/BDR election is finished. The DR/BDR election process may thereby allow for OSPF convergence and communication between each router 105-120 in network 100. The DR/BDR election process may result in slow convergence in large networks due to all routers/switch 105-125 within network 100 exchanging information during each election process.

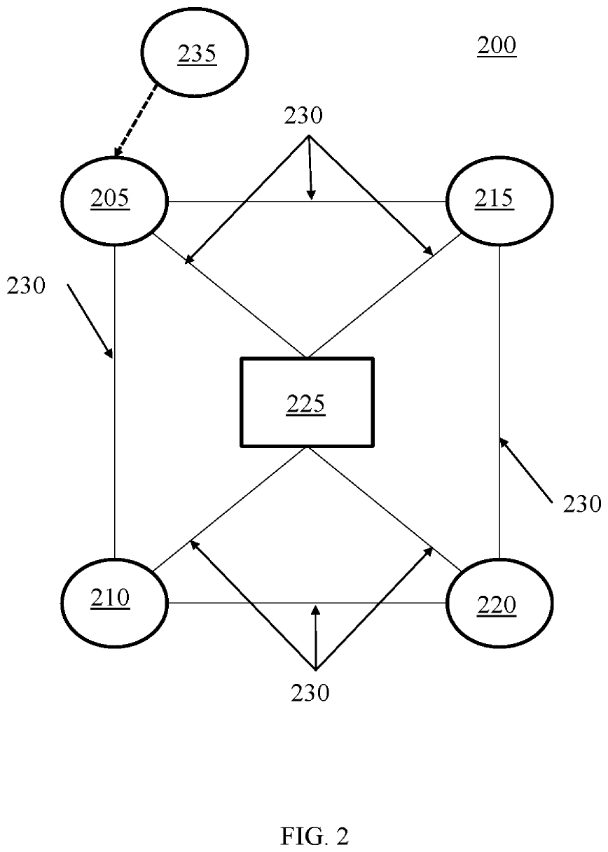

Referring to FIG. 2, a schematic representation of a topology for an OSPF network according to one or more examples of the present disclosure is shown. Network 200 includes a first router 205, a second router 210, a third router 215, a fourth router 220, and a switch 225. Routers/switch 205-225 may communicate with one another through connections 230. Connections 230 may be wired or wireless, thereby allowing routers/switch 205-225 to communicate therebetween. In this example, each router/switch 205-225 of network 200 maintains a copy of their specific ledger, thereby forming a blockchain network. A blockchain generally refers to a method for maintaining a distributed ledger across multiple parties, which in this example refers each router/switch 205-225, or node, of network 200. As such, the distributed ledger that is maintained is the same for each router/switch 205-225 in network 200.

A distributed ledger is a type of database that is shared, replicated, and synchronized among members in network 200. In this example, routers/switch 205-225 share the distributed ledger. The distributed ledgers may work by using consensus, cryptographic hashes, and/or digital signatures. Consensus ensures that the distributed ledgers are copies, such that the distributed ledger on each router/switch 205-225 of network 200 is the same. Consensus further maintains the security and decreases the risk of fraudulent access because tampering with the distributed ledger would may result in accessing multiple devices at the same time. Cryptographic hashes may refer to computational algorithms, that when a modification to distributed ledger occurs, results in a different hash value being computed, thereby providing an indication if the input is compromised. The cryptographic hashes thereby further ensure the integrity of modification to the distributed ledger and thus network 200. Digital signatures may include private keys that prevent changes to distributed ledger and network 200 from unauthorized nodes from outside network 200.

The distributed ledger may contain various types of information about specific routers/switch 205-225 in the network, as well as information about network 200 in general. For example, the distributed ledger may include routing information, device identifiers, cost, OSPF configuration, as well as OSPF authentication.

In certain implementations, authentication in OSPF may also be enabled in order to securely exchange routing update information between routers/switch 205-225. OSPF authentication may refer to authentication as either null, simple, or MD5. Null authentication is also referred to as Type 0 and means that no authentication information is included in the packet header. Simple, or plain text authentication, is also referred to as Type 1 and uses simple clear-text passwords. MD5 authentication is also referred to as Type 2 and uses MD5 cryptographic passwords. MD5 authentication provides higher security and uses the MD5 algorithm to compute a hash value from the contents of the OSPF packet along with a password, i.e., a key. The hash value is transmitted in the packet with the key ID and a non-decreasing sequence number. The receiver of the packet, which knows the same password, calculates its own hash value. If nothing in the message changes, the hash value of the receiver should match the has value of the sender, which is transmitted with the message. Authentication is thereby confirmed. By combining OSPF authentication, such as MD5 authentication, with the distributed ledger in blockchain network 200, OSPF neighbors in network 200 may be securely authenticated and information may be securely exchanged therebetween.

Before any router/switch 205-225 in network 200 communicates with a neighboring device or authenticates a modification to network 200, routers/switch 205-225 add information to their specific ledger copy, which is then spread to other ledger copies as the distributed ledger. As all routers/switch 205-225 in network 200 have the same copy of the distributed ledger, when a modification to network 200 is requested, such as authentication or changes to network 200, routers/switch 205-225 may access the distributed ledger. Only operations permitted by distributed ledger will be performed on routers/switch 205-225 and/or to network 200.

For example, in one implementation, router 205 may receive a communication from an external source 235. External source 235 may be attempting to access router 205, to provide updated software, to access information thereon, to gain access to network 200, or for other various reasons. Prior to allowing external source 235 access to router 205, router 205 may check the distributed ledger to determine whether external source 235 is permitted to access router 205. If external source 235 is authenticated by distributed ledger, external source 235 may access router 205 to perform the requested task. If external source 235 is not authorized by distributed ledger, external source 235 may be denied access to router 205.

Similarly, should router 215 communicate to router 205, router 205 may check the distributed ledger to authenticate the communication from router 215. If router 215 is authorized in the distributed ledger, router 215 may send information to router 205. If router 215 includes an aspect that is not authorized by the distributed ledger, access to router 205 may be denied. As such, should one device in network 200 be compromised, such as router 215, other devices in network 200 may deny communication with router 215, thereby preventing the entire network 200 from being compromised.

In operation, before any new OSPF operation is performed in network 200, the router/switch 205-225 performing the operation checks the distributed ledger received from network 200. From the distributed ledger, router/switch 205-225 checks for the parameters and checks the credentials of the sending device and/or the receiving device from where the packet was sent and to where the packet is routed. This information may be updated in the distributed ledger and a copy of the updated distributed ledger may be provided to each router/switch 205-225 in network 200. As such, an updated distributed ledger may be maintained that is the same for each router/switch 205-225 in network 200. By maintaining a copy of the same distributed ledger on each router/switch 205-225 in network 200, convergence time may be reduced, thereby resulting in increased network performance. Additionally, maintaining the distributed ledger may results in less computing and memory usage of specific router/switch 205-225 that may otherwise occur in OSPF networks.

Furthermore, use of distributed ledgers in blockchain network 200 may allow OSPF operations to proceed without DR/BDR election. By removing the DR and BDR, convergence time of blockchain network 200 may be reduced, thereby improving network performance.

Methods for using distributed ledgers in blockchain networks according to implementations of the present disclosure are discussed in detail below. Such methods may use aspects of network 200, discussed above, as well as other aspects of blockchain networks using distributed ledgers.

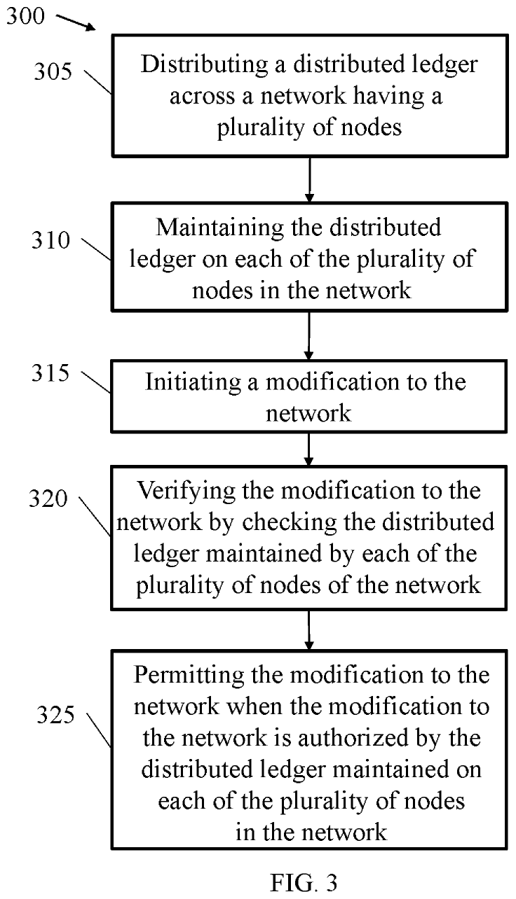

Referring to FIG. 3, a flowchart for a method 300 for network communication according to one or more examples of the present disclosure is shown. The method 300 may include distributing (305) a distributed ledger across a network having a plurality of nodes. The network may include two or more network devices, such as routers, switches, and the like. However, in certain networks, hundreds or even thousands of devices may be present. The devices may be part of a general network or may be divided into network areas, such as the OSPF areas explained above. Each device within the network may constitute a node, and as such, each node may have a duplicate copy of the distributed ledger. As explained above, the distributed ledger may include the same content for each node, thereby allowing each node to have common information about each other node and the network in general.

The distributed ledger may further include specific information about nodes within the network or about the network in general. For example, the distributed ledger may contain one or more of routing information, device identifiers, cost, open shortest path configurations, and/or open shortest path authentication. Other information not expressly identified herein may be included and the distributed ledger may be updated with new information as operations change.

The nodes within the network may include an open shortest path first routing protocol and communication between the nodes may follow open shortest path first authentication. As such, the nodes may communicate and allow the exchange of information therebetween in an efficient manner. Furthermore, the distributed ledger may result in no node within the network having a DR or BDR identification. Because the distributed ledger includes the same information for each node within the network, a node does not need to be a DR, as each node already has access to all information about other devices within the network, as well as information about the network in general. As no DR or BDR is identified, the DR/BDR election process does not occur, thereby allowing the network to function more efficiently.

In operation, the method 300 may further include maintaining (310) the distributed ledger on each of the plurality of nodes in the network. Maintaining (310) the distributed ledger may allow the distributed ledger to remain the same for each node within the network, even as changes/modifications to the network occur. For example, in operation, devices may be added or removed from the network, and as such, the distributed ledger may be modified so that each node within the network is aware of the changes. Additionally, access information or device specific information may be updated during operation, thereby resulting in changes to distributed ledger. While changes may occur to specific aspects of the network or specific network devices, the distributed ledger may be maintained so that all nodes within the network have an updated copy of the distributed ledger, and as such, may operate accordingly.

In operation, the method 300 may further include initiating (315) a modification to the network. The modification to the network may include adding or removing devices or otherwise changing an aspect of a network device or an aspect of the network in general. Network modification may occur as a result of scaling the specific network to meet new operational conditions. Network modification may further result from general maintenance, unexpected events, e.g., a router becomes inoperable, administrator error, attack from malicious software, addition of external devices, unexpected external access, and the like.

In operation, the method 300 may further include verifying (320) the modification to the network by checking the distributed ledger maintained by each of the plurality of nodes of the network. Verifying (320) may include checking the network modification to see if it is permitted according to information contained in the distributed ledger. Because each node in the network has the same copy of the distributed ledger, any modification may be detected and verified by each node within the network. As such, if a first node receives notification of a network modification, the first node can verify whether the network medication is allowable without communication with another node within the network. Verifying (320) may further include retrieving information from the distributed ledger maintained in one or more network nodes.

In operation, the method 300 may further include permitting (325) the modification to the network when the modification to the network is authorized by the distributed ledger maintained on each of the plurality of nodes in the network. If the modification does not violate the rules set forth in the distributed ledger, the modification may thereby be allowed to proceed. For example, if a new node is attempting to be added to the network, if the parameters for the new node are included in the distributed network, the new node may be added. Furthermore, if a software update is performed to one or more devices, the devices may verify the software update is scheduled in the distributed ledger and permit the update if the update is included.

In certain examples, a network administrator may add node information to the distributed ledger. As such, when a modification to the node about which the node information was added occurs, the network has the information necessary to permit the modification to the network. This may also provide a security check. For example, node information may be added, but the modification to the node may include a parameter that was not specified in the node information. In the event the node information refers to adding a new node having specific attributes, should the new node not match the attributes, the new node may not be added. Such security checks may thereby prevent the malicious addition of new nodes. Such a security check may further prevent nodes having compromised software or hardware from being added to the network.

As a network expands or is otherwise modified, a network administrator may modify the distributed ledger and subsequently distribute the distributed ledger to each node in the network. In this way, each node may receive an updated distributed ledger as changes occur, thereby allowing each device within the network to have access to the same network node information and network information. In certain operations, a specific node may record a transaction in the distributed ledger. In such a situation, a node may record a transaction between one or more nodes in the distributed ledger and then the distributed ledger may be redistributed between each node in the network. As such, as a modification to an aspect of the network occurs, the distributed ledger may remain the same for each node within the network. For example, if a device is added to the network, a node may make a modification to the ledger indicating that the topology of the network has changed and include information about the new node in the distributed ledger. The node may then redistribute the distributed ledger to all other nodes in the network, thereby allowing the change to be recognized by all nodes within the network.

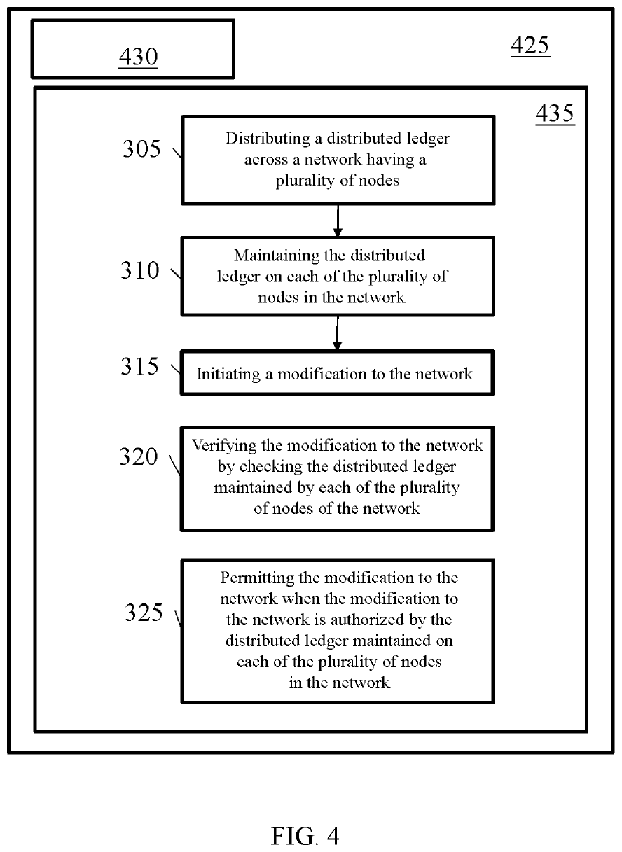

Turning to FIG. 4, an example computing device with a hardware processor and accessible machine-readable instructions is shown in accordance with one or more examples of the present disclosure. FIG. 4 provides is an example computing device 425, with a hardware processor 430, and accessible machine-readable instructions stored on a machine-readable medium 435 for providing communication within a network as discussed above with respect to one or more disclosed example implementations. FIG. 4 illustrates computing device 425 configured to perform the flow described in blocks 305, 310, 315, 320, and 325, discussed in detail with respect to FIG. 3. However, computing device 425 may also be configured to perform the flow of other methods, techniques, functions, or processes described in this disclosure.

A machine-readable storage medium, such as 435 of FIG. 4, may include both volatile and nonvolatile, removable and non-removable media, and may be any electronic, magnetic, optical, or other physical storage device that contains or stores executable instructions, data structures, program module, or other data accessible to a processor, for example firmware, erasable programmable read-only memory (“EPROM”), random access memory (“RAM”), non-volatile random access memory (“NVRAM”), optical disk, solid state drive (“SSD”), flash memory chips, and the like. The machine-readable storage medium may be a non-transitory storage medium, where the term “non-transitory” does not encompass transitory propagating signals.

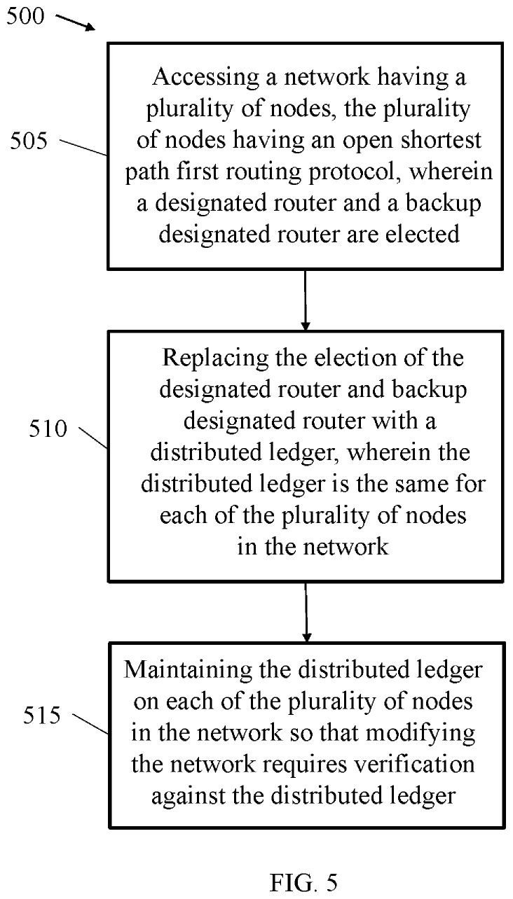

Turning to FIG. 5, a flowchart for a method 500 of network communication according to examples is shown. In operation, the method 500 may include accessing (505) a network having a plurality of nodes. The plurality of nodes may have an OSPF routing protocol, such that a DR and a BDR are elected. As explained above with respect to FIG. 1, during the process of setting up a network using the OSPF protocol, the network establishes a DR and a BDR. The DR thereby receives LSAs from other routing devices in their area and originates network link advertisements on behalf of the network, as well as establishes adjacencies with other routing devices in the network area. The BDR is elected to perform the tasks of the DR should the DR become unavailable. The DR/BDR election may result in slow convergence within the network, as well as result in expensive infrastructure and slower speeds for geographically disparate networks.

In operation, the method 500 may further include replacing (510) the DR and BDR designation with a distributed ledger. The distributed ledger is the same for each of the plurality of nodes in the network and is stored locally on each of the nodes in the network. The distributed ledger may contain information about specific devices on the network, as well as information about the network in general. Specific examples of the type of information that may be included in the distributed ledger is discussed in detail above, such as one or more of routing information, device identifiers, cost, OSPF configurations, and/or OSPF authentication. The distributed ledger may thereby replace the need for a DR and/or BDR because each of the nodes has information about the network, so a specific router, i.e., the DR, does not have to disseminate information about the network and specific device on the network to each of the other devices. By providing each node within the network with a copy of a distributed ledger, each device knows the state of the network within a specific time instance. Additionally, as modifications to the network may occur, each node within the network has access to a new state of the network.

In operation, the method 500 may further include maintaining (515) the distributed ledger on each of the plurality of nodes in the network so that modifying the network includes verification against the distributed ledger. By maintaining (515) the distributed ledger on each of the plurality of nodes, each of the plurality of nodes within the network knows the state of the network and devices included therewith. As such, when a modification to a specific device on the network, or to some other aspect of the network occurs, each device through the distributed ledger can determine whether to allow or prevent the modification from occurring. For example, if a software update is provided to a device and the software update is not authorized in the distributed ledger, the device may prevent the software update from occurring.

Similarly, if external access is attempted in order to access one or more devices in the network, the devices may prevent the external access if the access is not allowed by the distributed ledger. Additionally, specific devices may write additional information to the distributed ledger, indicating a change to a device or a change within the network. The updated distributed ledger with new information may subsequently be distributed to all other devices within the network, thereby allowing all devices within the network to know the current state of the network.

In certain examples, modifying the network may include verifying the network modification by checking the distributed ledger maintained by each of the plurality of nodes of the network and permitting the modification to the network when the modification to the network is authorized by the distributed ledger as maintained on each of the plurality of nodes in the network. Because the distributed ledger is the same for each of the plurality of nodes, each node of the network may decide whether to authorize a modification to a specific device or the network in general. Similarly, each node of the network may decide to deny a specific modification.

By removing the DR/BDR election process, and thus the establishment of a DR/BDR, the network may provide faster convergence, as each node within the network knows the state of the network at any given time. Further, modifications to the network may be faster, with fewer errors, as each device has a copy of the distributed ledger that includes necessary information about the network. Additionally, by using OSPF authentication in addition to a distributed ledger, the network may be more secure, thereby decreasing external threats to the network. For example, because each node includes a copy of the distributed ledger, the blockchain network may prevent spoofing, denial of service attacks, distributed denial of service attacks, address resolution protocol cache poisoning, man-in-the-middle attacks, and the like. Furthermore, the distributed ledger may result in decreased processor and memory use, as a DR does not have to send information to each other node within a network area on a regular basis.

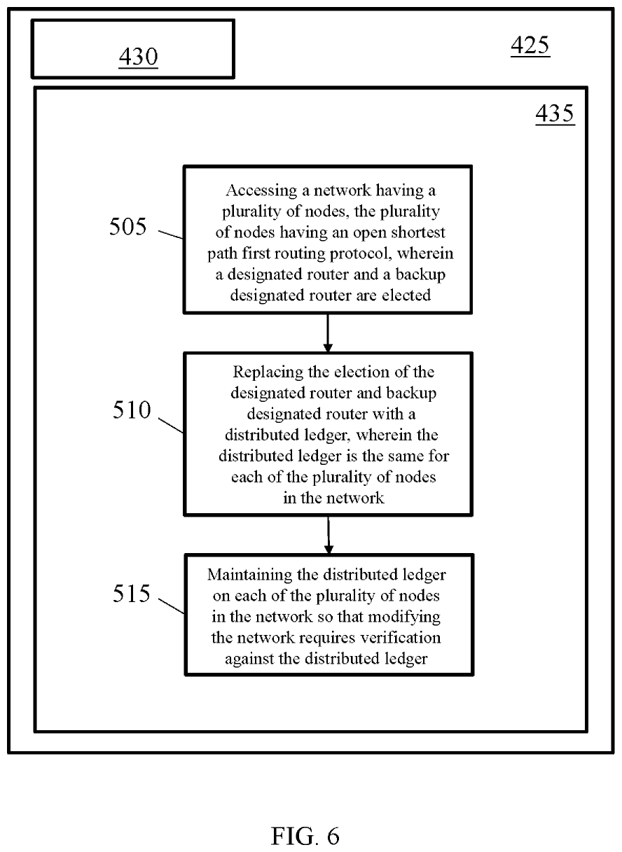

Turning now to FIG. 6, an example computing device with a hardware processor and accessible machine-readable instructions is shown in, accordance with one or more examples of the present disclosure. FIG. 6 provides, the same structural components discussed above with respect to FIG. 6, and as such, for purposes of clarity, only the differences in the figures will be discussed herein. FIG. 6 provides is an example computing device 425, with a hardware processor 430, and accessible machine-readable instructions stored on a machine-readable medium 435 for providing communication within a network as discussed above with respect to one or more disclosed example implementations. FIG. 4 illustrates computing device 425 configured to perform the flow described in blocks 505, 510, and 515, discussed in detail with respect to FIG. 5. However, computing device 425 may also be configured to perform the flow of other methods, techniques, functions, or processes described in this disclosure.

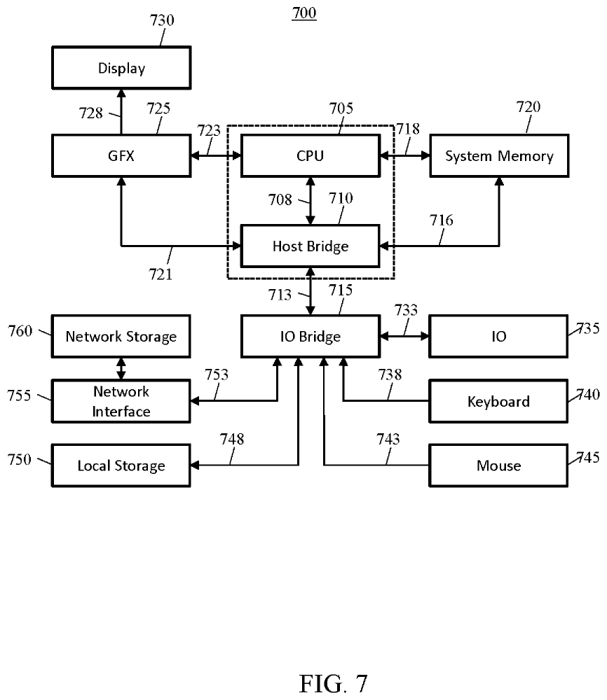

Referring now to FIG. 7, a schematic representation of a computer processing device 700 that may be used to implement functions and processes in accordance with one or more examples of the present disclosure is shown. FIG. 7 illustrates a computer processing device 700 that may be used to implement the systems, methods, and processes of this disclosure. For example, computing device 700 illustrated in FIG. 7 could represent a client device or a physical server device and include either hardware or virtual processor(s) depending on the level of abstraction of the computing device. In some instances (without abstraction), computing device 700 and its elements, as shown in FIG. 7, each relate to physical hardware. Alternatively, in some instances one, more, or all of the elements could be implemented using emulators or virtual machines as levels of abstraction. In any case, no matter how many levels of abstraction away from the physical hardware, computing device 700 at its lowest level may be implemented on physical hardware. In one implementation, computing device 700 may allow a subscriber to remotely access one or more data centers. Similarly, the management tool used by the subscriber may include a software solution that runs on such a computing device 700.

FIG. 7 shows a computing system 700 in accordance with one or more examples of the present disclosure. Computing system 700 may be used to implement the incremental checking, to create causality graphs, or may be the target of such incremental checking. Computing system 700 may include one or more central processing units (singular “CPU” or plural “CPUs”) 705 disposed on one or more printed circuit boards (not otherwise shown). Each of the one or more CPUs 705 may be a single-core processor (not independently illustrated) or a multi-core processor (not independently illustrated). Multi-core processors typically include a plurality of processor cores (not shown) disposed on the same physical die (not shown) or a plurality of processor cores (not shown) disposed on multiple die (not shown) that are collectively disposed within the same mechanical package (not shown). Computing system 700 may include one or more core logic devices such as, for example, host bridge 710 and input/output (“IO”) bridge 715.

CPU 705 may include an interface 708 to host bridge 710, an interface 718 to system memory 720, and an interface 723 to one or more IO devices, such as, for example, graphics processing unit (“GFX”) 725. GFX 725 may include one or more graphics processor cores (not independently shown) and an interface 728 to display 730. In certain embodiments, CPU 705 may integrate the functionality of GFX 725 and interface directly (not shown) with display 730. Host bridge 710 may include an interface 708 to CPU 705, an interface 713 to IO bridge 715, for embodiments where CPU 705 does not include interface 718 to system memory 720, an interface 716 to system memory 720, and for embodiments where CPU 705 does not include integrated GFX 725 or interface 723 to GFX 725, an interface 721 to GFX 725. One of ordinary skill in the art will recognize that CPU 705 and host bridge 710 may be integrated, in whole or in part, to reduce chip count, motherboard footprint, thermal design power, and power consumption. IO bridge 715 may include an interface 713 to host bridge 710, one or more interfaces 733 to one or more IO expansion devices 735, an interface 738 to keyboard 740, an interface 743 to mouse 745, an interface 748 to one or more local storage devices 750, and an interface 753 to one or more network interface devices 755.

Each local storage device 750 may be a solid-state memory device, a solid-state memory device array, a hard disk drive, a hard disk drive array, or any other non-transitory computer readable medium. Each network interface device 755 may provide one or more network interfaces including, for example, Ethernet, Fibre Channel, WiMAX, Wi-Fi, Bluetooth, or any other network protocol suitable to facilitate networked communications. Computing system 700 may include one or more network-attached storage devices 760 in addition to, or instead of, one or more local storage devices 750. Network-attached storage device 760 may be a solid-state memory device, a solid-state memory device array, a hard disk drive, a hard disk drive array, or any other non-transitory computer readable medium. Network-attached storage device 760 may or may not be collocated with computing system 700 and may be accessible to computing system 700 via one or more network interfaces provided by one or more network interface devices 755.

One of ordinary skill in the art will recognize that computing system 700 may include one or more application specific integrated circuits (“ASICs”) that are configured to perform a certain function, such as, for example, hashing (not shown), in a more efficient manner. The one or more ASICs may interface directly with an interface of CPU 705, host bridge 760, or IO bridge 715. Alternatively, an application-specific computing system (not shown), sometimes referred to as mining systems, may be reduced to only those components necessary to perform the desired function, such as hashing via one or more hashing ASICs, to reduce chip count, motherboard footprint, thermal design power, and power consumption. As such, one of ordinary skill in the art will recognize that the one or more CPUs 705, host bridge 710, IO bridge 715, or ASICs or various sub-sets, super-sets, or combinations of functions or features thereof, may be integrated, in whole or in part, or distributed among various devices in a way that may vary based on an application, design, or form factor in accordance with one or more example embodiments. As such, the description of computing system 700 is merely exemplary and not intended to limit the type, kind, or configuration of components that constitute a computing system suitable for performing computing operations, including, but not limited to, hashing functions. Additionally, one of ordinary skill in the art will recognize that computing system 700, an application specific computing system (not shown), or combination thereof, may be disposed in a standalone, desktop, server, or rack mountable form factor.

One of ordinary skill in the art will recognize that computing system 700 may be a cloud-based server, a server, a workstation, a desktop, a laptop, a netbook, a tablet, a smartphone, a mobile device, and/or any other type of computing system in accordance with one or more example embodiments.

It should be appreciated that all combinations of the foregoing concepts (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

While the present teachings have been described in conjunction with various examples, it is not intended that the present teachings be limited to such examples. The above-described examples may be implemented in any of numerous ways.

Also, the technology described herein may be embodied as a method, of which at least one example has been provided. The acts performed as part of the method may be ordered in any suitable way. Accordingly, examples may be constructed in which acts are performed in an order different than illustrated, which may include performing some acts simultaneously, even though shown as sequential acts in illustrative examples.

Advantages of one or more example embodiments may include one or more of the following:

In one or more examples, systems and methods disclosed herein may be used to provide fast and secure OSPF convergence without DR/BDR election.

In one or more examples, systems and methods disclosed herein may be used to increase or otherwise modify a network without experiencing downtime.

In one or more examples, systems and methods disclosed herein may be used to increase computing system efficiency by decreasing the use of computing resources and memory.

In one or more examples, systems and methods disclosed herein may be used to decrease memory and computing use by removing the DR/BDR election process from the OSPF protocol.

Not all embodiments will necessarily manifest all these advantages. To the extent that various embodiments may manifest one or more of these advantages, not all of them will do so to the same degree.

While the claimed subject matter has been described with respect to the above-noted embodiments, those skilled in the art, having the benefit of this disclosure, will recognize that other embodiments may be devised that are within the scope of claims below as illustrated by the example embodiments disclosed herein. Accordingly, the scope of the protection sought should be limited only by the appended claims.

What is claimed is:

1. A method for network communication, the method comprising:
distributing a distributed ledger across a network having a plurality of nodes;
maintaining the distributed ledger on each of the plurality of nodes of the network;
initiating a modification to the network;
verifying the modification to the network by checking the distributed ledger maintained by each of the plurality of nodes of the network; and
permitting the modification to the network when the modification to the network is authorized by the distributed ledger maintained on each of the plurality of nodes in the network.

2. The method of claim 1, wherein the distributed ledger comprises at least one of routing information, device identifiers, cost, open shortest path configurations, and open shortest path authentication.

3. The method of claim 1, further comprising adding node information to the distributed ledger before permitting the modification to the network.

4. The method of claim 1, further comprising rejecting the modification when the modification is not included in the distributed ledger.

5. The method of claim 1, wherein the distributed ledger is the same for each node in the network.

6. The method of claim 1, wherein verifying the network modification further comprises retrieving information from the distributed ledger maintained within each node in the network.

7. The method of claim 1, further comprising modifying the distributed ledger and distributing the distributed ledger to each of the nodes of the network.

8. The method of claim 1, wherein each of the plurality of nodes comprises an open shortest path first routing protocol.

9. The method of claim 1, further comprising recording a transaction between one or more nodes of the network in the distributed ledger.

10. The method of claim 1, wherein the plurality of nodes does not comprise a designated router and a backup designated router designation.

11. The method of claim 1, further comprising communicating between the plurality of nodes, wherein the communicating comprises open shortest path first authentication.

12. A network comprising:
a plurality of nodes within the network, the plurality of nodes having an open shortest path first routing protocol; and
a distributed ledger residing in the plurality of nodes, the distributed ledger being the same in each of the plurality of nodes, and before a modification to the network is authorized, the modification is verified against the distributed ledger and modifications authorized by the distributed ledger are allowed

13. The network of claim 12, further comprising:
an additional node, wherein the additional node is added to the network.

14. The network of claim 12, wherein the plurality of nodes comprises at least one of a router and a switch.

15. The network of claim 12, wherein the distributed ledger comprises node information and network information.

16. The network of claim 12, wherein the plurality of nodes does not include a designated router or a backup designated router.

17. A method for network communication, the method comprising:
accessing a network having a plurality of nodes, the plurality of nodes having an open shortest path first routing protocol, a designated router, and a backup designated;
replacing the designated router and the backup designated router with a distributed ledger, the distributed ledger being the same for each of the plurality of nodes in the network; and
maintaining the distributed ledger on each of the plurality of nodes in the network so that modifying the network includes verification against the distributed ledger.

18. The method of claim 17, further comprising modifying the network, wherein the modifying comprises verifying the network modification by checking the distributed ledger maintained by each of the plurality of nodes of the network and permitting the modification to the network when the modification to the network is authorized by the distributed ledger maintained on each of the plurality of nodes in the network.

19. The method of claim 17, wherein the distributed ledger comprises at least one of routing information, device identifiers, cost, open shortest path configurations, and open shortest path authentication.

20. The method of claim 17, wherein communication between the plurality of nodes comprises open shortest path first authentication.
